(19) United States
(12) Patent Application Publication
(10) Pub. No.: US 2014/0306591 A1
(43) Pub. Date: Oct. 16, 2014

(54) Wall-mounted kitchen-cabinet with storage of non-potable water out of reverse osmosis (RO) water treating machine

(71) Applicants: Ying Lin Cai, Guangdong (CN); Chao Fou Hsu, Kaohsiung City (TW)

(72) Inventors: Ying Lin Cai, Guangdong (CN); Chao Fou Hsu, Kaohsiung City (TW)

(21) Appl. No.: 14/249,686

(22) Filed: Apr. 10, 2014

Related U.S. Application Data
(60) Provisional application No. 61/810,840, filed on Apr. 11, 2013.

(51) Int. Cl. A47B 77/04; C02F 1/44; B01D 61/08

(52) U.S. Cl. CPC A47B 77/04; B01D 61/08; C02F 1/441
USPC 312/245

(57) ABSTRACT

The present invention provides a wall-mounted kitchen-cabinet with storage of non-potable water out of reverse osmosis (RO) water treating machine comprising a case body of kitchen-cabinet, a water storage tank, a cover of water storage tank, an inlet pipe and an outlet pipe. The water storage tank is contained in the case body of kitchen-cabinet for storage of the non-potable water output from the reverse osmosis (RO) water treating machine. The outlet pipe includes a front opening and an end opening such that the end opening connects to a water stopcock while the front opening connects to the water outlet of the water storage tank via the pipe outlet of the case body of kitchen-cabinet. By means of the water stopcock to get the non-potable water, user can achieve the effect in fully usage the non-potable water by habitually practice of washing cooking materials or washing hands.

This application claims the benefit of provisional U.S. Patent Application No. 61/810,840, filed Apr. 11, 2013, and incorporated herein by reference.

### FIELD OF THE PRESENT INVENTION

The present invention relates to a wall-mounted kitchen-cabinet with storage of non-potable water out of reverse osmosis (RO) water treating machine, particularly for an innovating contrivance in combining the wall-mounted kitchen-cabinet with the water storage tank of the non-potable water. By means of the water storage tank contained in the case body of kitchen-cabinet for storage of the non-potable water output from the reverse osmosis (RO) water treating machine, then the water stopcock gets the non-potable water. Thus, user can achieve the effect in fully usage the non-potable water by habitually practice of washing cooking materials or washing hands.

### BACKGROUND OF THE INVENTION

Currently, the pollution issue for the water resource of river is getting more serious owing to dumping by liquid wastes and garbage of factory and household as well as livestock excreta incurred by the industrialization and neglect of environmental protection. Moreover, the people confidence in the daily drinking tap water is deprived the because water reservoir on building top roof is getting dirty and water pipes in the plumbing structure is eroded due to improper maintenance. Therefore, people cannot help but install a (household reverse osmosis (RO) water treating machine) in their kitchen room to assured themselves that their drinking water is safe.

Please refer to FIGS. 1 and 2, which show a conventional household reverse osmosis (RO) water treating machine 100 with a means for handling drainage of non-potable water thereof in a modern residential home kitchen 1. The conventional household reverse osmosis (RO) water treating machine 100 comprises a booster pump 101, a first filter 102, a second filter 103, a third filter 104, a reverse osmosis (RO) membrane 200, a pressurized tank of pure water 300 and a gooseneck faucet 301 such that the first filter 102 is a filter cartridge for filtering coarse impurities or sediments, the second filter 103 is a filter cartridge for filtering fine impurities or sediments and the third filter 104, which is a filter cartridge of activated carbon, wherein the booster pump 101, first filter 102, second filter 103, third filter 104 and reverse osmosis (RO) membrane 200 are combined in an assembly case 105, which is put in a locker 7 located under a cleaning sink 2 of a kitchen platform 3 together with the pressurized tank of pure water 300 in separated manner for conserving the space of kitchen 1. Whereas, the gooseneck faucet 301 is singly fixed on the top surface outside of the cleaning sink 2. All the jobsite installation related to parts aforesaid in the kitchen 1 of user/purchaser will be done by a professional technician sent by the machine vendor. As shown in FIG. 2, the jobsite installation of the household reverse osmosis (RO) water treating machine 100 in the kitchen 1 is processed as below: firstly, connect the water inlet of the booster pump 101 to the water pipe of the tap water faucet 5 by a pipe (not shown in figures); secondly, connect the pure water outlet 201 of the reverse osmosis (RO) membrane 200 to the pressurized tank of pure water 300 via one end of the three-way manifold check valve 302; thirdly, further connect the pure water outlet 201 output from another end of the three-way manifold check valve 302 to the gooseneck faucet 301 via a water conduit P2; and finally, connect the non-potable water outlet 202 of the reverse osmosis (RO) membrane 200 to a drain pipe P4 under the cleaning sink 2 via a water conduit P3 to finish the overall jobsite installation of the household reverse osmosis (RO) water treating machine 100 in the kitchen 1.

Normally, the producing filtered water of the household reverse osmosis (RO) water treating machine 100 is performed by following steps. As indicated by the hollow arrowhead shown in FIG. 2, after having been pressurized by the booster pump 101, tap-water W orderly passes the first filter 102, second filter 103, third filter 104 and reverse osmosis (RO) membrane 200 for filtration. Then pure water W1 and non-potable water W2 of high concentration are generated out of the reverse osmosis (RO) membrane 200 respectively. After having generated out of the reverse osmosis (RO) membrane 200, the (pure water W1) flows into the pressurized tank of pure water 300 via the three-way manifold check valve 302 for storage (as indicated by the arrowhead with arrow shaft of solid line shown in FIG. 2) while the non-potable water W2 flows into the drain pipe P4 via the water conduit P3 for discharging (as indicated by the arrowhead with arrow shaft of dotted line shown in FIG. 2). Wherein, first filter 102 and second filter 103 respectively filters out various coarse and fine suspended particle impurities, sediments or organic substances while third filter 104 absorbs chlorine and other chemical matters form the tap water. Moreover, the pore aperture for the mesh of the reverse osmosis (RO) membrane 200 is about 100 pico-square meters (10⁻¹⁰ M²) only, which filters out various heavy metals and a variety of viruses. Thereby, the pure water W1 flowing out of the pure water outlet 201 serves as drinking water. Whereas the non-potable water W2 of filtered high concentration flowing out of the non-potable water outlet 202 should be discharged out via the drain pipe P4 as it can not serve as drinking water so that the waste of water resource is incurred by the discharged non-potable water W2.

Besides, the mesh of the reverse osmosis (RO) membrane 200 is going to be clogged by the sticky impurities and mineral deposits/residues agglomerate retaining adhered and adhering stranded on the surface thereof after it is having been used for a long time. In order to maintain the reverse osmosis filtrating effect and elongate service life span of the elongate, during the household reverse osmosis (RO) water treating machine 100 being in stand-by state, the IC circuit device 106 in the assembly case 105 is preset to run back-flushing cycle (or called back-wash cycle) to the reverse osmosis (RO) membrane 200 in 30-60 seconds for every period about 6-8 hours. When the back-flushing cycle starts to run, the proportional valve 107 shunted on the non-potable water outlet 202 restricts all the tap-water W flowing into the reverse osmosis (RO) membrane 200 only flows out of the non-potable water outlet 202 so that the sticky impurities and mineral deposits/residues agglomerate retaining adhered and adhering stranded on the surface of the reverse osmosis (RO) membrane 200 are scoured out and discharged out via the drain pipe P4 for back-flushing function. Thereby, the non-potable water W2 generated by the back-flushing cycle should be flowed out of the non-potable water outlet 202 and discharged out of the drain pipe P4 as it can neither serve as drinking water so that the waste of water resource is also incurred.

For solving foregoing issues in the waste of water resource incurred by the non-potable water W2 discharged in the producing drinking water or generated by the back-flushing cycle, many solving ways have been provided. All the solving ways can be induced into following three categories.

First way: provide an extra container for collecting non-potable water W2.

In this solving way, during the jobsite installation of the household reverse osmosis (RO) water treating machine 100, the non-potable water outlet 202 of the reverse osmosis (RO) membrane 200 is not connected to a drain pipe P4 under the cleaning sink 2 via a water conduit P3. But, the water conduit P3 is elongated to have its extended outlet end exposed outside of the kitchen platform 3 in the kitchen 1 instead for discharging the non-potable water W2 into a household water bucket F or other container prepared by the user (as shown in FIG. 1-A) for watering the flowers, wiping the floor, flushing the toilet and cleaning the lavatory to achieve the purpose in using the water resource to the full extent (for example: disclosure in line 2 counting backwards in page 3 to line 1 in page 4 of the specification for the granted Taiwan (R.O.C.) new model patent in serial number of 302084 published on Feb. 17, 1996 by the inventor of the present invention). However, in daily lifestyle speaking, other than occupies limited space in kitchen, to provide extra water bucket F or other container for collecting non-potable water W2 of the household reverse osmosis (RO) water treating machine 100 cause unsafe secret worry in the household life because it not only needs regularly replacing another water bucket to prevent overflowing of the existing water bucket F or other container but also needs carefully watch out not to tumble down the existing water bucket F or other container. Moreover, according survey by the maintenance technicians regularly sent to the user houses by the vendors, most users always ask the technicians to resume their household reverse osmosis (RO) water treating machine 100 into normal condition by connecting the water conduit P3 of the non-potable water W2 to the drain pipe P4, and abandoning the extra water bucket F or other container for collecting non-potable water W2 due to inconvenience. Obviously, this solving way is neither reliable nor feasible, but reveals the manufacturer of the household reverse osmosis (RO) water treating machine 100 does not take good responsibility in product design. Therefore, some vendors of the household reverse osmosis (RO) water treating machine 100 provides an extra water storage container in connecting to the non-potable water outlet 202 of the reverse osmosis (RO) membrane 200 for collecting the non-potable water W2 as example of Mainland China patent in number of 100340491. But this only change the form instead of the means as the user still need to prepare extra water bucket F or other container for receiving the non-potable water W2 flowing out of the water storage container provided by the vendor to be used in watering the flowers, wiping the floor, flushing the toilet and cleaning the lavatory. The essence of the issue is not solved yet.

Second way: Dispense the non-potable water W2 to the toilet water tank.

In this solving way, either by means of an extra water pipe to shunt the non-potable water W2 to the toilet water tank in the household lavatory for flushing the toilet thereof, or by means of an extra water pipe to indirectly distribute the non-potable water W2 collected in an extra water bucket prepared to the toilet water tank in the household lavatory for flushing the toilet thereof as examples of Taiwan (R.O.C.) New Model patents in numbers of 214743, 582406 and M360078. However, there is a drawback in this solving way that an extra plumbing construction is inevitable. Since interior plumbing pipes are finished at the completion of the residential building construction, the extra water pipe for the non-potable water W2 should be spread in pipe-exposed manner, which needs to drill extra piping holes in the existing wall in the kitchen and lavatory. Thereby, it not only causes extra plumbing task and cost but also destroys artistic appearance of the interior decoration. Thus, no existing case is found in this solving way as none of the users is willing to take it. In other words, this solving way is neither reliable nor feasible.

Third way: Feedback the collected non-potable water W2 for more filtration.

In this solving way, provide an extra container for collecting non-potable water W2 and feedback the collected non-potable water W2 to the reverse osmosis (RO) membrane 200 of the household reverse osmosis (RO) water treating machine 100 for second or more filtration as examples of Taiwan (R.O.C.) New Model patents in numbers of 353981, M326437, M380335 and M396710. However, this solving way is an erroneous design owing to the misunderstanding or ignorance to the concept and structure of the reverse osmosis (RO) membrane 200. Because the pore aperture for the mesh of the reverse osmosis (RO) membrane 200 is about 100 pico-square meters (10⁻¹⁰ M²) only, the mesh of the reverse osmosis (RO) membrane 200 is going to be clogged by the sticky impurities and mineral deposits/residues agglomerate retaining adhered and adhering stranded on the surface thereof after it is having been used for a long time. The “desalination rate” of the reverse osmosis (RO) membrane 200 is decreased if collected non-potable water W2 is fed through it for second or more filtration. It is a general knowledge that the specification of the reverse osmosis (RO) membrane 200 is classified by the “desalination rate” thereof to mark relative quantity of filtered pure water available. Therefore, the decrease of the “desalination rate” for the related reverse osmosis (RO) membrane 200 not only shortens the serving life span thereof but also jeopardizes the safety of the drinking water filtered thereby. In other wards, by collecting non-potable water W2 and re-feeding the collected non-potable water W2 to the reverse osmosis (RO) membrane 200 of the household reverse osmosis (RO) water treating machine 100 for second or more filtration aforesaid not only reduces the quantity of the filter drinking water but also causes the mesh of the reverse osmosis (RO) membrane 200 being easily clogged by more sticky impurities and mineral deposits/residues agglomerate retaining adhered and adhering stranded on the surface thereof, which results in more replacing cost incurred by early damage of the reverse osmosis (RO) membrane 200. Therefore, this solving way is not a prudent means but to put the cart before the horse that it is only a matter in suffering a big loss for a little gain. Again, this solving way is neither reliable nor feasible.

With foregoing issues, how to work out a effective and feasible means for fully usage of the non-potable water W2 produced by the household reverse osmosis (RO) water treating machine 100 without harmfully affecting the “desalination rate” of the reverse osmosis (RO) membrane 200 becomes a critical and urgent necessity.

### SUMMARY OF THE INVENTION

The primary object of the present invention is to provide a wall-mounted kitchen-cabinet with storage of non-potable water out of reverse osmosis (RO) water treating machine comprising a case body of kitchen-cabinet, a water storage tank, a cover of water storage tank, an inlet pipe and an outlet pipe, wherein the case body of kitchen-cabinet is mounted on a wall over a cleaning sink in a kitchen; the water storage tank is contained in the case body of kitchen-cabinet for storage of the non-potable water output from the reverse osmosis (RO) water treating machine; and the outlet pipe includes a front opening and an end opening such that the end opening connects to a water stopcock while the front opening connects to the water outlet of the water storage tank via the pipe outlet of the case body of kitchen-cabinet. By means of simple operation of using the water stopcock to get the non-potable water, the present invention can achieve the effect in fully usage the non-potable water discharged by the household reverse osmosis (RO) water treating machine by habitually practice of washing cooking materials or washing hands in the cleaning sink of the kitchen.

The other object of the present invention is to provide a wall-mounted kitchen-cabinet with storage of non-potable water out of reverse osmosis (RO) water treating machine such that the case body of kitchen-cabinet can either be singly mounted on the wall or juxtaposed with existing wall-mounted kitchen-cabinet on the wall of the kitchen in abutted manner so that the artistic appearance for the wall of the kitchen is not destroyed by keeping the dimensional size of the case body of kitchen-cabinet the same as that of the existing wall-mounted kitchen-cabinet. Thus, the user of the present invention not only can enjoy the convenience of the household reverse osmosis (RO) water treating machine but also can eliminate doubt and anxiety about the interior decoration of the kitchen being destroyed.

### BRIEF DESCRIPTION OF THE DRAWINGS

FIG. 1 is a perspective schematic view showing a conventional household reverse osmosis (RO) water treating machine installed in a modern residential home kitchen.

FIG. 1-A is a perspective schematic view showing a conventional household reverse osmosis (RO) water treating machine with a means for handling drainage of non-potable water thereof in a modern residential home kitchen.

FIG. 2 is a cross sectional view taken from the 2-2 line in previous FIG. 1.

FIG. 3 is the first perspective schematic view showing a wall-mounted kitchen-cabinet installed in a modern residential home kitchen for the first exemplary preferred embodiment of the present invention.

FIG. 4 is the second perspective schematic view showing a wall-mounted kitchen-cabinet installed in a modern residential home kitchen for the first exemplary preferred embodiment of the present invention.

FIG. 5 is a perspective exploded view of a wall-mounted kitchen-cabinet for the first exemplary preferred embodiment of the present invention.

FIG. 6 is a cross sectional view taken from the 6-6 line in previous FIG. 3.

FIG. 7 is an operational schematic view of a wall-mounted kitchen-cabinet for the first exemplary preferred embodiment of the present invention.

FIG. 8 is a perspective exploded view of a wall-mounted kitchen-cabinet for the second exemplary preferred embodiment of the present invention.

FIG. 9 is the first operational schematic view of a wall-mounted kitchen-cabinet for the second exemplary preferred embodiment of the present invention.

FIG. 10 is the second operational schematic view of a wall-mounted kitchen-cabinet for the second exemplary preferred embodiment of the present invention.

FIG. 11 is the first cross sectional view of a wall-mounted kitchen-cabinet for the third exemplary preferred embodiment of the present invention.

FIG. 11-A is the second cross sectional view of a wall-mounted kitchen-cabinet for the third exemplary preferred embodiment of the present invention.

FIG. 12 is a perspective exploded view of a wall-mounted kitchen-cabinet for the fourth exemplary preferred embodiment of the present invention.

FIG. 13 is the first operational schematic view of a wall-mounted kitchen-cabinet for the fourth exemplary preferred embodiment of the present invention.

FIG. 14 is the second operational schematic view of a wall-mounted kitchen-cabinet for the fourth exemplary preferred embodiment of the present invention.

FIG. 15 is a perspective exploded view of a wall-mounted kitchen-cabinet for another exemplary preferred embodiment of the present invention.

FIG. 16 is a perspective schematic view for the body of a wall-mounted kitchen-cabinet for the other exemplary preferred embodiment of the present invention.

FIG. 17 is a perspective schematic for the water storage tank of a wall-mounted kitchen-cabinet for another exemplary preferred embodiment of the present invention.

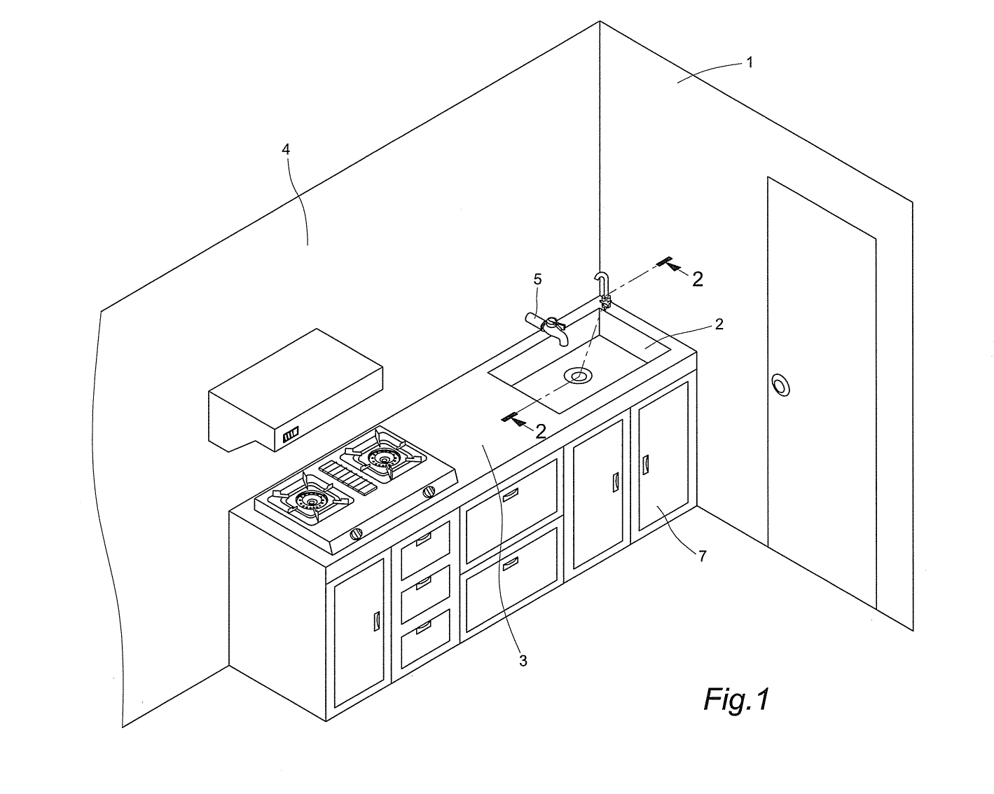

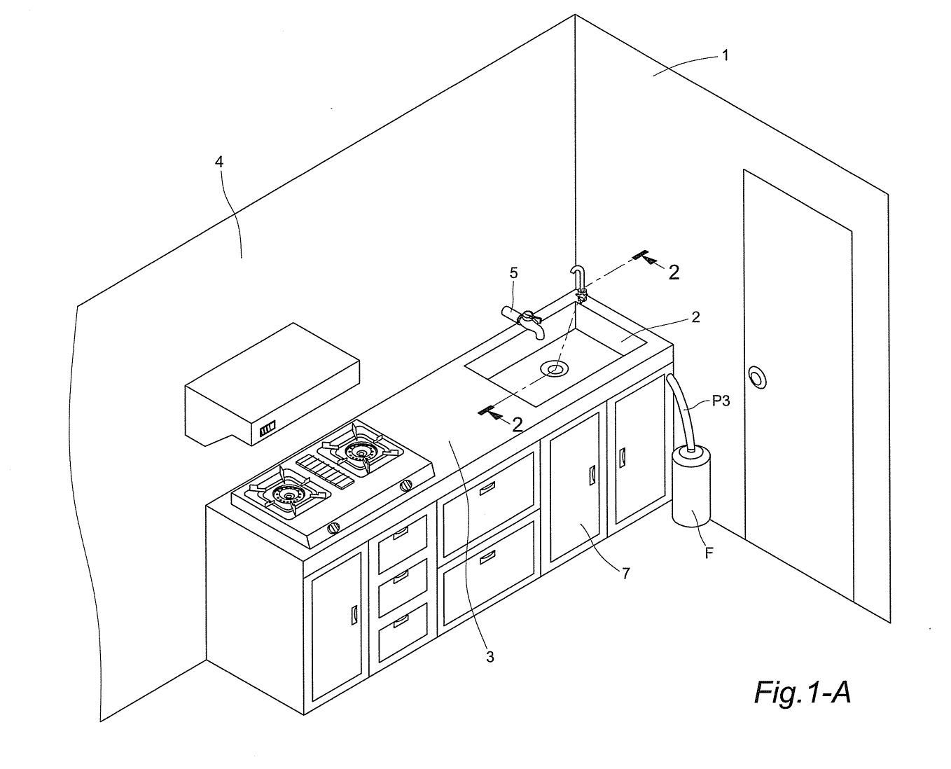

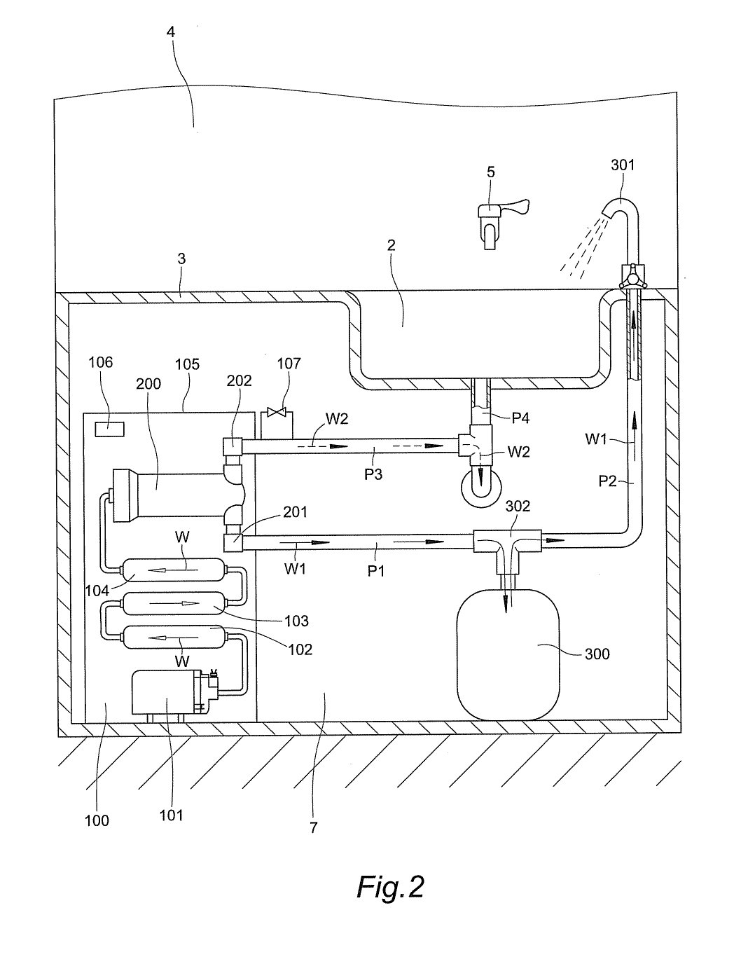

### DETAILED DESCRIPTION OF THE PREFERRED EMBODIMENTS

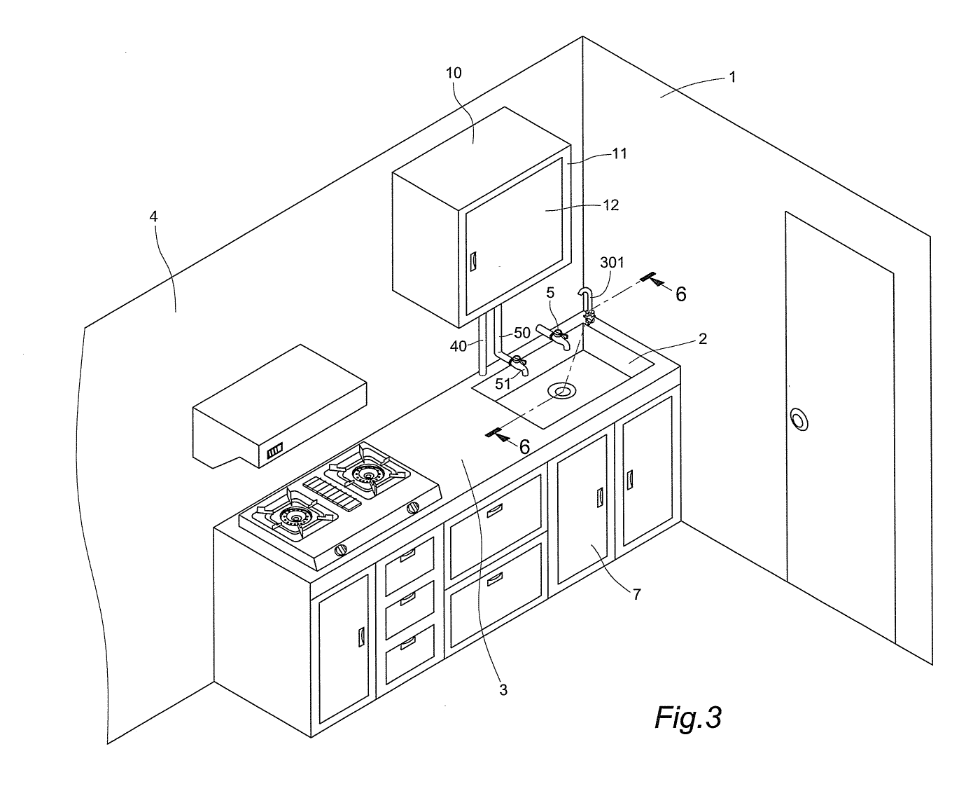

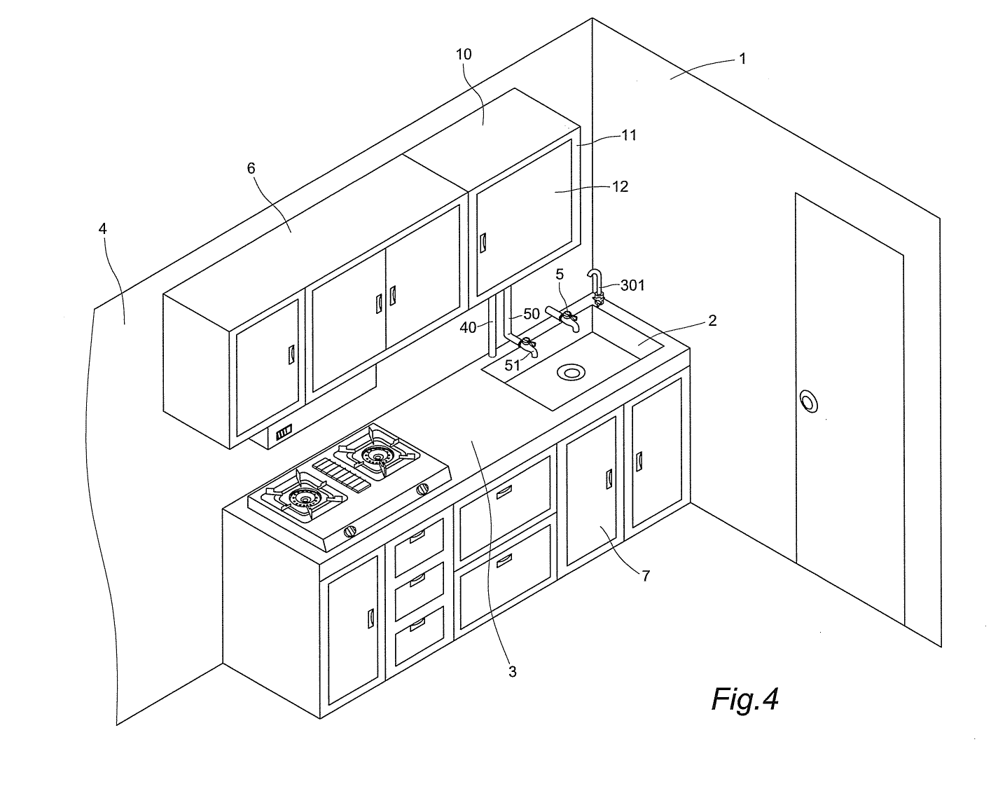

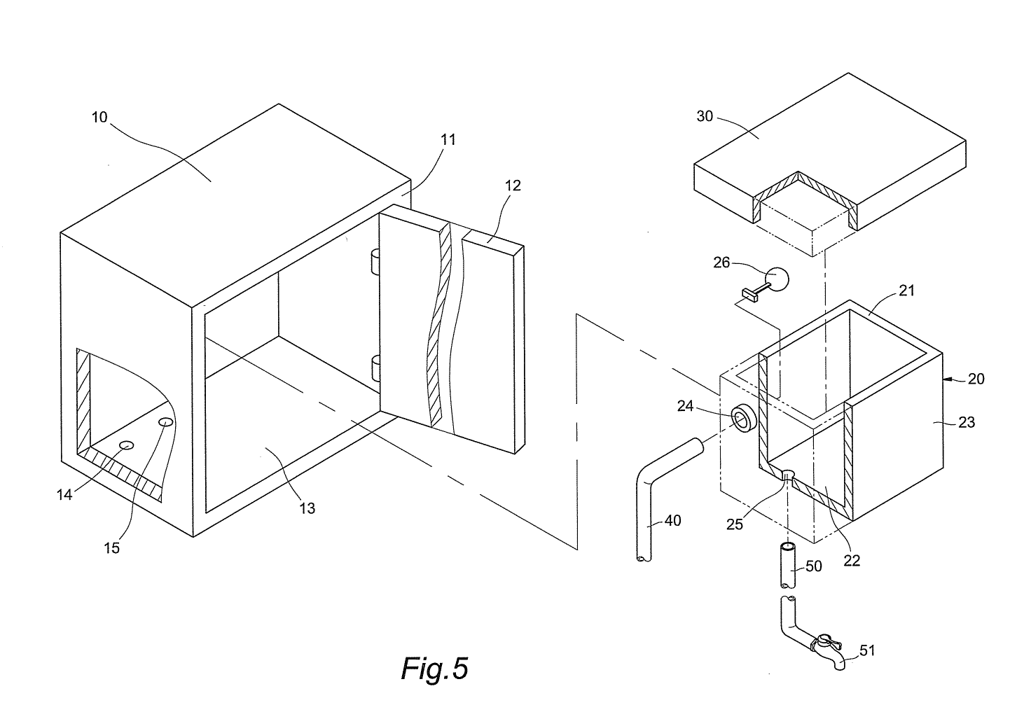

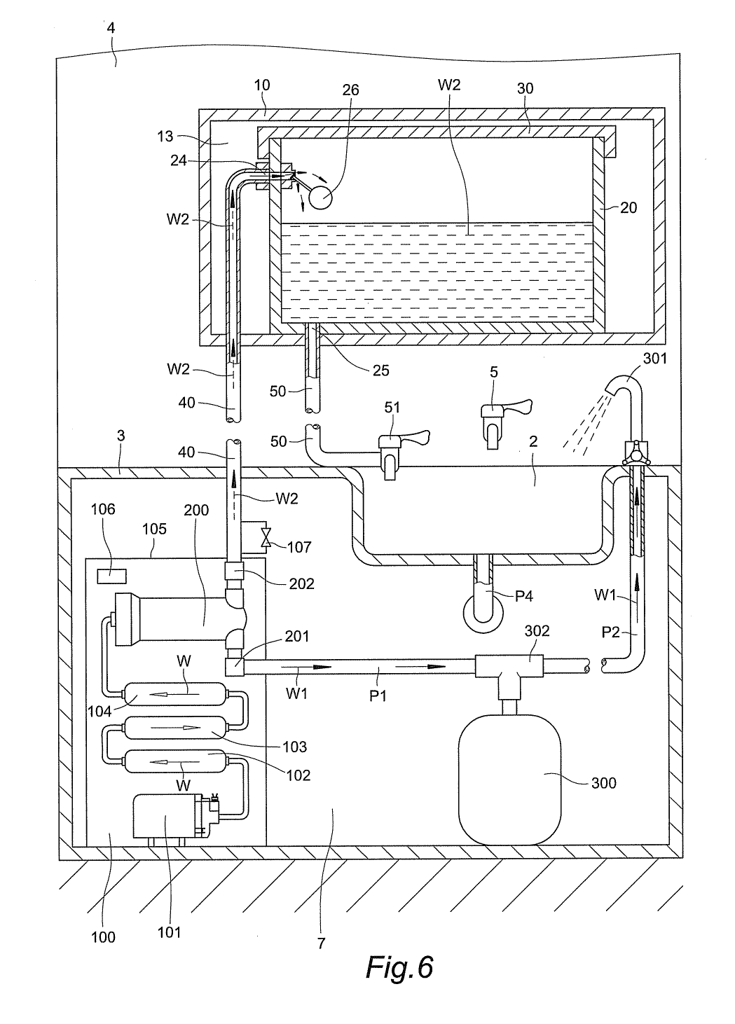

Please refer to FIGS. 3 through 6. The wall-mounted kitchen-cabinet with storage of non-potable water out of reverse osmosis (RO) water treating machine of present invention comprises a case body of kitchen-cabinet 10, a water storage tank 20, a cover of water storage tank 30, an inlet pipe 40 and an outlet pipe 50, wherein said case body of kitchen-cabinet 10, which is a hollow case mounted on a wall 4 over a cleaning sink 2 in a kitchen 1, includes a front face 11 hinged with a pivoting door panel of kitchen-cabinet 12, a bottom surface 13 with a pipe inlet 14 and a pipe outlet 15; said water storage tank 20, which is a hollow case contained in the case body of kitchen-cabinet 10 for storage of the non-potable water W2 output from the reverse osmosis (RO) membrane 200 of the household reverse osmosis (RO) water treating machine 100, includes an open top surface 21, a closed bottom surface 22 with a water outlet 25, four side faces 23 encompassed an integral hollow cuboid, four side faces 23 encompassed an integral hollow cuboid, a water inlet 24 disposed in one side faces 23 in manner near to opening of the top surface 21, and a float switch 26 is disposed in the internal wall in manner of beneath the water inlet 24 of the water storage tank 20, the float switch 26 is made of a floating ball and a disk connected by a rigid rod such that the disk diameter is slightly bigger that the internal diameter of the water inlet 24, and the lower rim of the disk is hinged on corresponding internal lower rim of the water inlet 24; said cover of water storage tank 30 is a slab to cover the top surface 21 of the water storage tank 20 for preventing dust from getting into the water storage tank 20; said inlet pipe 40 includes a front opening and an end opening such that the front opening connects to the non-potable water outlet 202 of the reverse osmosis (RO) membrane 200 in the household reverse osmosis (RO) water treating machine 100 (as shown in FIG. 6) while the end opening connects to the water inlet 24 of the water storage tank 20 via the pipe inlet 14 of the case body of kitchen-cabinet 10 for directing the non-potable water W2 from the reverse osmosis (RO) membrane 200 into the water storage tank 20; and said outlet pipe 50, includes a front opening and an end opening such that the front opening connects to the water outlet 25 of the water storage tank 20 via the pipe outlet 15 of the case body of kitchen-cabinet 10 while end opening connects to a water stopcock 51, which is disposed over a cleaning sink 2 (as shown in FIG. 3).

Wherein, the case body of kitchen-cabinet 10 can either be singly mounted on the wall 4, which is above the cleaning sink 2 of the kitchen 1 (as shown in FIG. 3), or juxtaposed with existing wall-mounted kitchen-cabinet 6 on the wall 4 of the kitchen 1 in abutted manner (as shown in FIG. 4) so that the artistic appearance for the wall 4 of the kitchen 1 is not destroyed by keeping the dimensional size of the case body of kitchen-cabinet 10 the same as that of the existing wall-mounted kitchen-cabinet 6.

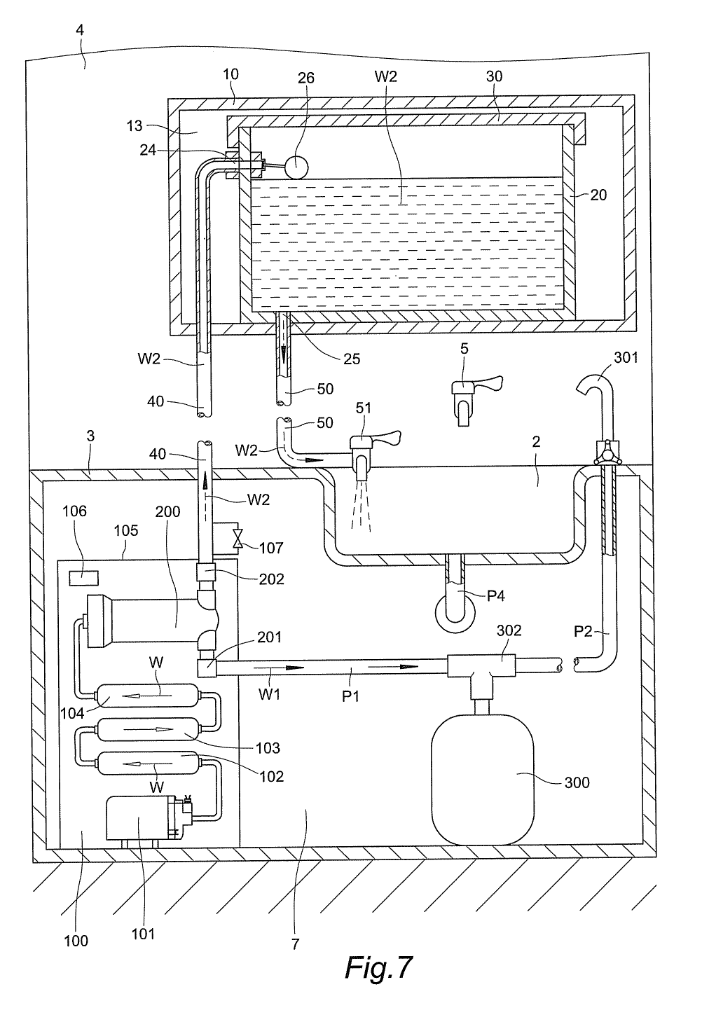

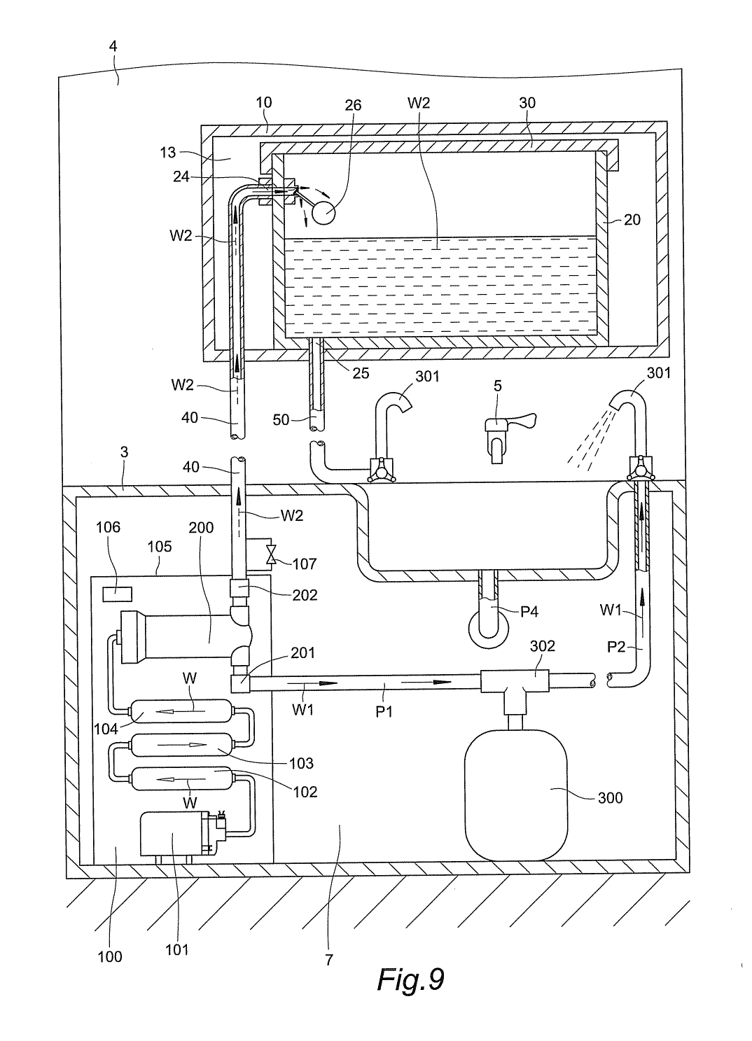

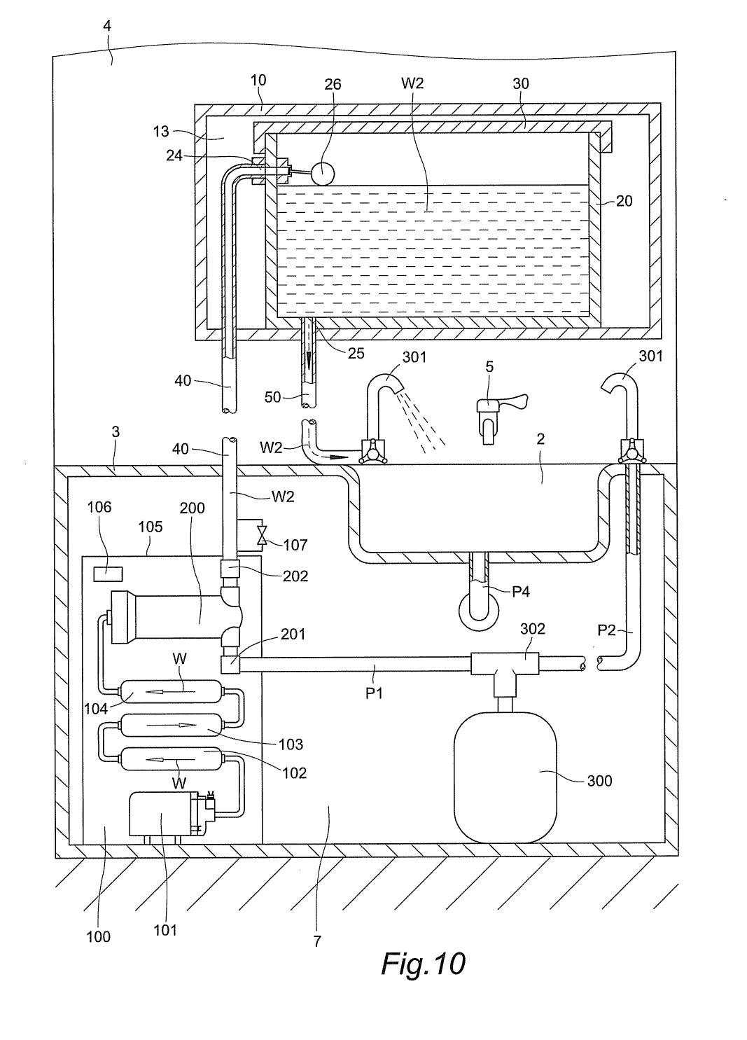

Please refer to FIGS. 6 and 7, which show operation for producing filtered drinking water by a household reverse osmosis (RO) water treating machine 100 in a wall-mounted kitchen-cabinet for the first exemplary preferred embodiment of the present invention. During producing filtered drinking water, tap-water W (as indicated by the hollow arrowhead shown in FIG. 6), after being pressurized by the booster pump 101, orderly passes the first filter 102, second filter 103, third filter 104 and reverse osmosis (RO) membrane 200, where the tap-water W is finally filtered to produce pure water W1 and non-potable water W2 of high concentration respectively; The pure water W1 (as indicated by the arrowhead with arrow shaft of solid line shown in FIG. 6) orderly passes a water conduit P1 and three-way check valve 302, then flows into a pressurized tank of pure water 300 for storage while the non-potable water W2 (as indicated by the arrowhead with arrow shaft of dotted line shown in FIG. 6) flows into the water storage tank 20 for storage orderly via the inlet pipe 40 and the water inlet 24 of the water storage tank 20. When user needs to wash cooking materials or wash hands, he/she just turns open the water stopcock 51 of the outlet pipe 50 above the cleaning sink 2 to let the non-potable water W2 in the water storage tank 20 of the case body of kitchen-cabinet 10 run out of the water stopcock 51 by gravity of potential energy without any effort (as shown in FIG. 7). The simple operation of using the water stopcock 51 to get the non-potable water W2 of the present invention is just the same as operation of conventional faucet 5 to get the tap-water W. Therefore, the present invention can achieve the effect in fully usage the non-potable water W2 discharged by the household reverse osmosis (RO) water treating machine 100 by habitually practice of washing cooking materials or washing hands in the cleaning sink 2 of the kitchen 1. Moreover, because the float switch 26 is made of a floating ball and a disk connected by a rigid rod such that the disk diameter is slightly bigger that the internal diameter of the water inlet 24, and the lower rim of the disk is hinged on corresponding internal lower rim of the water inlet 24, the floating ball of the float switch 26 is pushed up by the water buoyancy so that the disk of the disk is pivoted counter-clock-wise (CCW) around the hinged lower rim to close the water inlet 24 when the water level of the non-potable water W2 in the water storage tank 20 gradually elevating up (as shown from FIG. 9 to FIG. 10). Thus, the overflowing of the non-potable water W2 out of the water storage tank 20 is prevented.

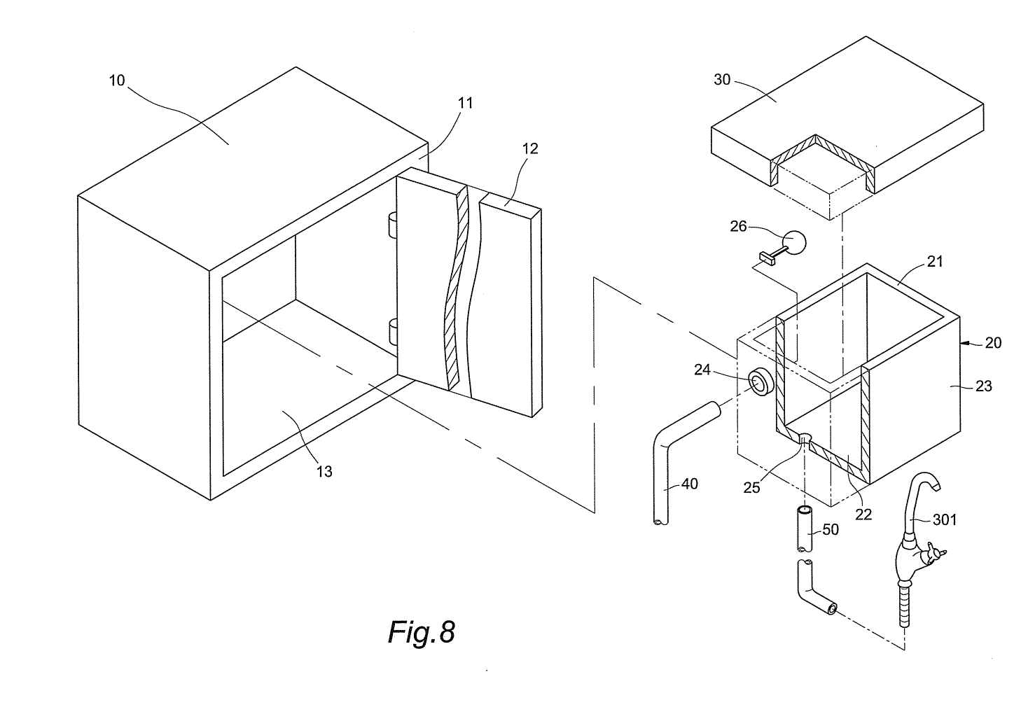

Please refer to FIGS. 8 and 10, which show a wall-mounted kitchen-cabinet for the second exemplary preferred embodiment of the present invention. In this wall-mounted kitchen-cabinet, a gooseneck faucet 301 instead of the water stopcock 51 is connected to the end opening of the outlet pipe 50 (as shown in FIGS. 8 and 9) to enhance flexibility and maneuverability in using the non-potable water W2 flowed out of the water storage tank 20 in the case body of kitchen-cabinet 10 (as shown in FIG. 10). Likewise, the simple operation of using the gooseneck faucet 301 to get the non-potable water W2 of the present invention can achieve the effect in fully usage the non-potable water W2 discharged by the household reverse osmosis (RO) water treating machine 100 by habitually practice of washing cooking materials or washing hands in the cleaning sink 2 of the kitchen 1.

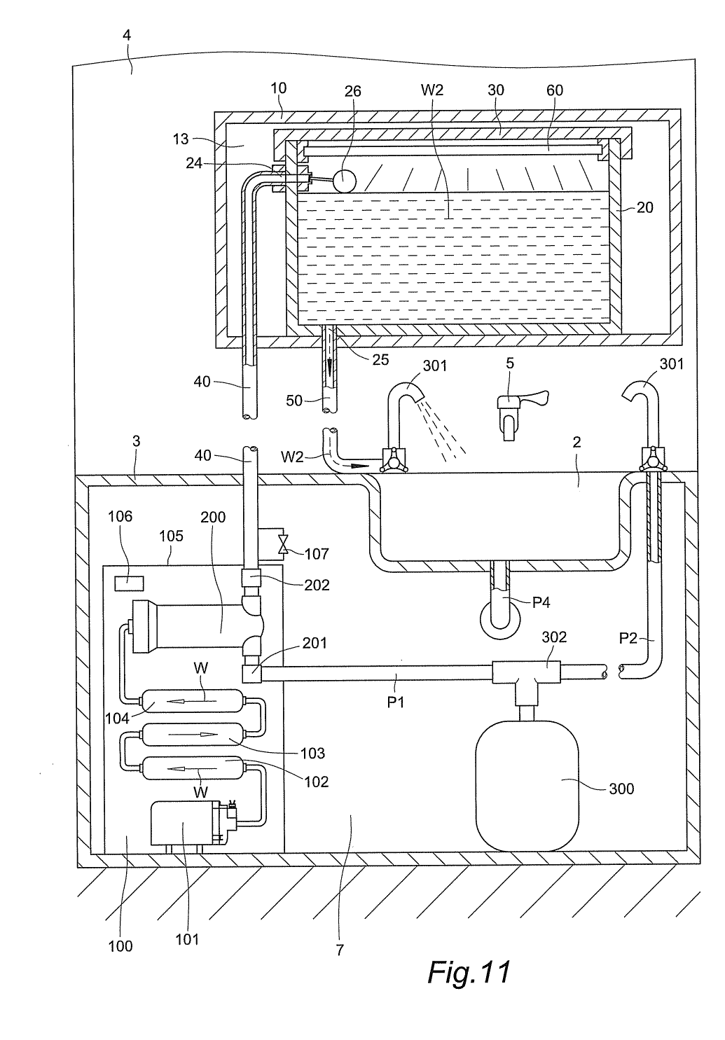

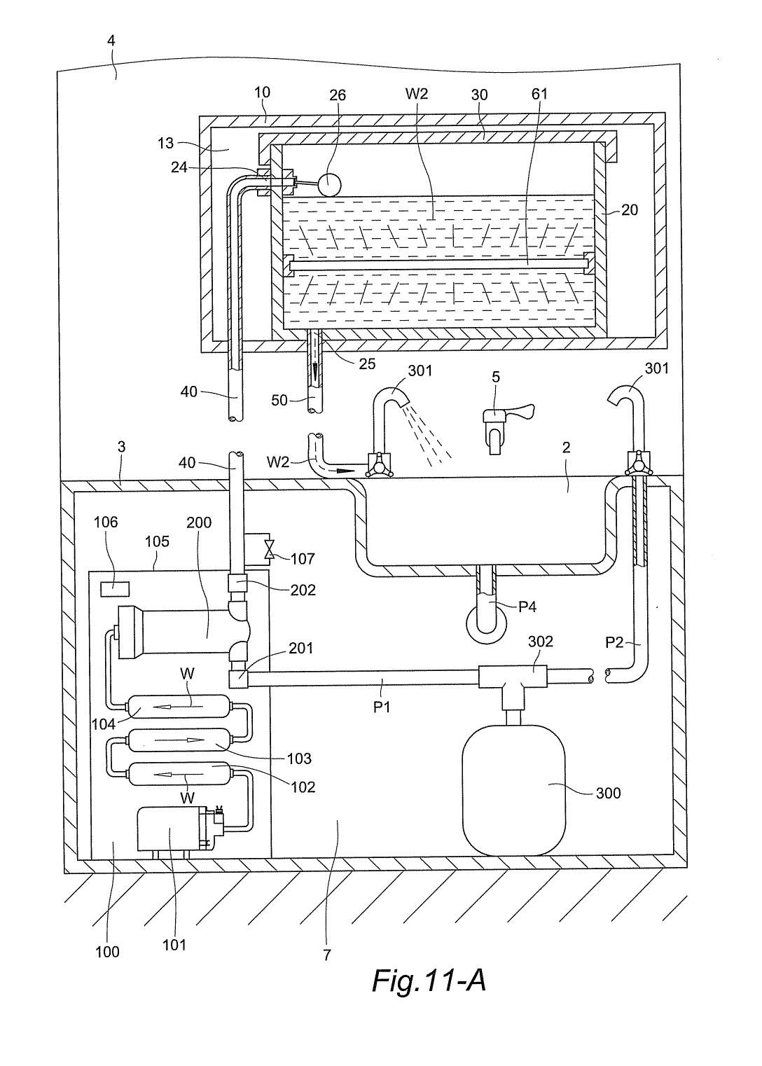

Please refer to FIGS. 11 and 11-A, which show a wall-mounted kitchen-cabinet for the third exemplary preferred embodiment of the present invention. In normal condition, the contact between the water storage tank 20 and cover of water storage tank 30 is not hermetically sealed so that the non-potable water W2 in the water storage tank 20 may become a cultivating environment for harmful microorganism growing due to existing air if the non-potable water W2 is not used out immediately. In this wall-mounted kitchen-cabinet, an ultraviolet (UV) lamp 60 is further disposed in the internal wall in manner of beneath of the cover of water storage tank 30 (as shown in FIG. 11) to serve as a disinfecting means for sterilizing these harmful microorganisms grown in the non-potable water W2 by means of the effective germicidal capability thereof. Furthermore, the ultraviolet (UV) lamp 60 can be replaced by a submersible ultraviolet (UV) lamp 61 (as shown in FIG. 11-A) disposed in the water storage tank 20, which has the same germicidal effectiveness to sterilize these harmful microorganisms grown in the non-potable water W2 of the water storage tank 20.

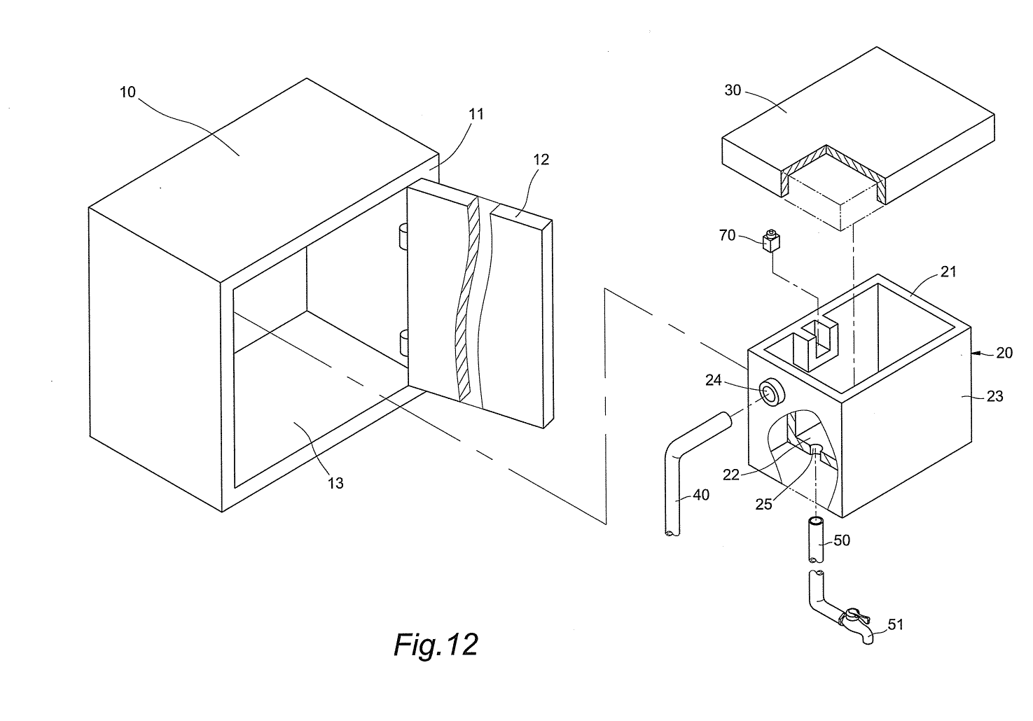

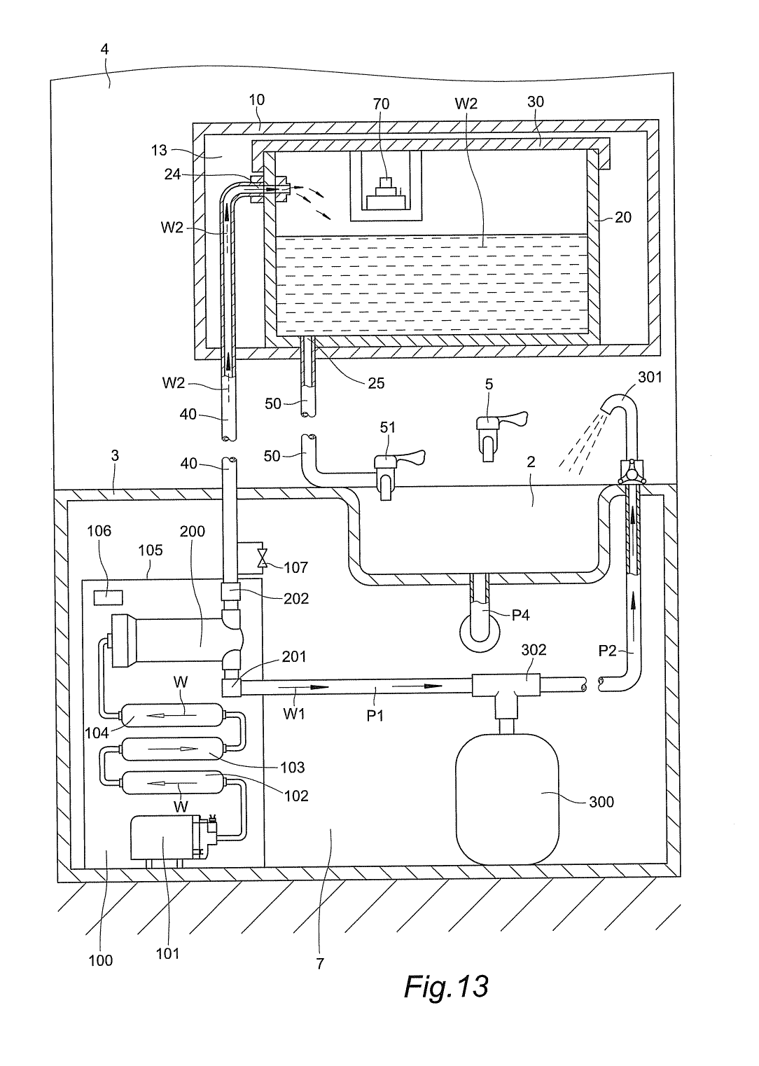

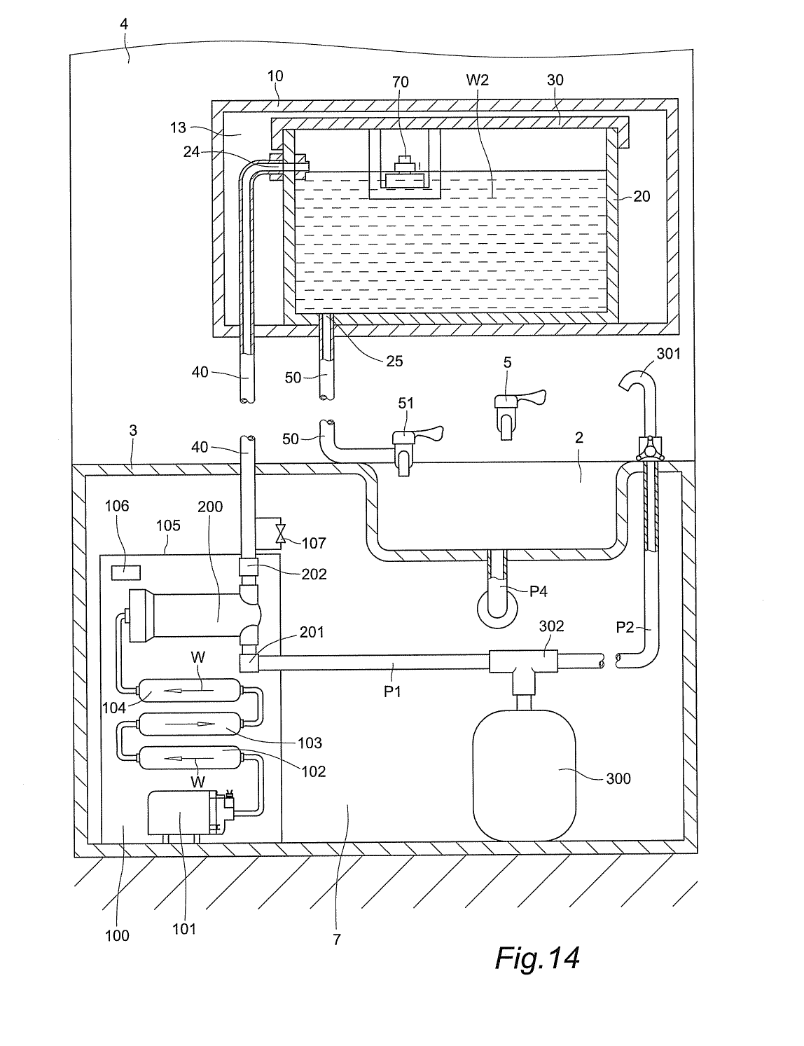

Please refer to FIGS. 12 through 14, which show a wall-mounted kitchen-cabinet for the fourth exemplary preferred embodiment of the present invention. In this wall-mounted kitchen-cabinet, an electronic water level detector 70 is disposed in the internal wall in manner of near to the top surface 21 of the water storage tank 20 to sense the threshold of water level for the non-potable water W2 in the water storage tank 20 and to relay a trigger signal to a IC circuit device 106 for stopping the operation of the booster pump 101 when the water level of the non-potable water W2 in the water storage tank 20 gradually elevating up (as shown from FIG. 3 to FIG. 14). Thus, the overflowing of the non-potable water W2 out of the water storage tank 20 is prevented.

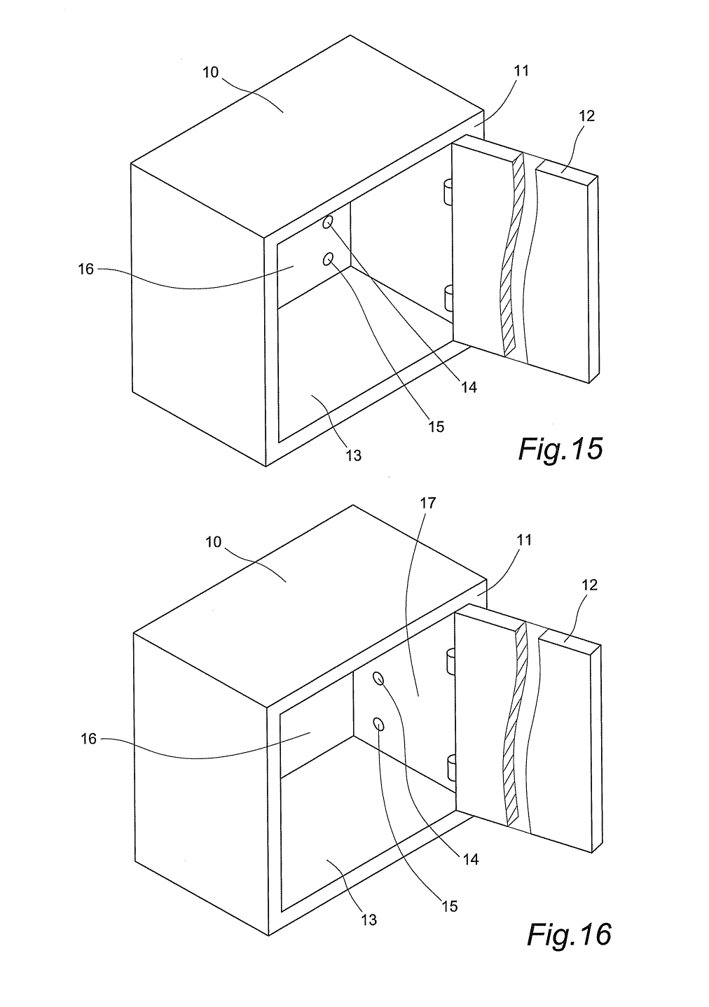

Please refer to FIG. 15, which shows a wall-mounted kitchen-cabinet for another exemplary preferred embodiment of the present invention. In this wall-mounted kitchen-cabinet, the pipe inlet 14 and pipe outlet 15 in the case body of kitchen-cabinet 10 is adapted to dispose on the back face 16 of the case body of kitchen-cabinet 10.

Please refer to FIG. 16, which shows a body of a wall-mounted kitchen-cabinet for the other exemplary preferred embodiment of the present invention. In this wall-mounted kitchen-cabinet, the pipe inlet 14 and pipe outlet 15 in the case body of kitchen-cabinet 10 is adapted to dispose on the lateral face 17 of the case body of kitchen-cabinet 10.

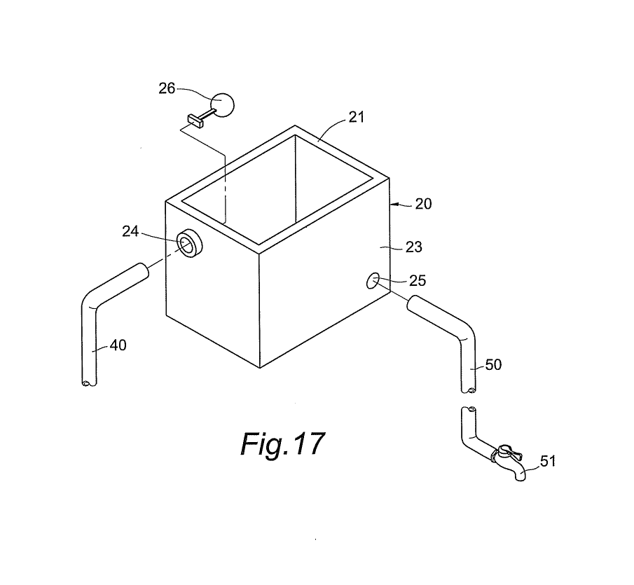

Please refer to FIG. 17, which shows a water storage tank of a wall-mounted kitchen-cabinet for another exemplary preferred embodiment of the present invention. In this wall-mounted kitchen-cabinet, the water outlet 25 in the water storage tank 20 is adapted to dispose on the side face 23 of the water storage tank 20.

In conclusion the disclosure heretofore, the present invention, which totally subverts all conventional solving ways used in non-potable water W2 discharged by the household reverse osmosis (RO) water treating machine 100, originates an innovating contrivance in combining the wall-mounted kitchen-cabinet 6 with the water storage tank 20 of the non-potable water W2 so that it not only imparts the wall-mounted kitchen-cabinet 6 a new creative function but also achieves the effective for fully usage of the non-potable water W2 with benefits neither occupying useful space of the kitchen 1 nor destroying the original artistic appearance of the kitchen 1. Thereby, the user of the present invention can achieve the effect in fully usage the non-potable water W2 discharged by the household reverse osmosis (RO) water treating machine 100 by habitually practice of washing cooking materials or washing hands in the cleaning sink 2 of the kitchen 1 without extra plumbing construction and cost for directing the non-potable water W2 into toilet water tank incurred by the conventional solving ways. Thus, the user of the present invention not only can enjoy the convenience of the household reverse osmosis (RO) water treating machine 100 without any doubt and anxiety but also can promote the safety concept of the household drinking water. Accordingly, we submit the patent application for the present invention in accordance with related patent laws because it meets the basic criterion of the patentability.

What is claimed is:

1. A wall-mounted kitchen-cabinet with storage of non-potable water out of reverse osmosis (RO) water treating machine comprises a case body of kitchen-cabinet, a water storage tank, a cover of water storage tank, an inlet pipe and an outlet pipe, wherein said case body of kitchen-cabinet, which is a hollow case mounted on a wall over a cleaning sink in a kitchen, includes a front face hinged with a pivoting door panel of kitchen-cabinet, a bottom surface with a pipe inlet and a pipe outlet; said water storage tank, which is a hollow case contained in the case body of kitchen-cabinet for storage of the non-potable water output from the reverse osmosis (RO) water treating machine, includes an open top surface, a closed bottom surface with a water outlet, four side faces encompassed an integral hollow cuboid, and a water inlet disposed in one side faces in manner near to opening of the top surface; said cover of water storage tank is a slab to cover the top surface of the water storage tank for preventing dust from getting into the water storage tank; said inlet pipe includes a front opening and an end opening such that the front opening connects to the non-potable water outlet of a reverse osmosis (RO) membrane in the reverse osmosis (RO) water treating machine while the end opening connects to the water inlet of the water storage tank via the pipe inlet of the case body of kitchen-cabinet for directing the non-potable water from the reverse osmosis (RO) membrane into the water storage tank; and said outlet pipe includes a front opening and an end opening such that the end opening connects to a water stopcock while the front opening connects to the water outlet of the water storage tank via the pipe outlet of the case body of kitchen-cabinet.

2. The wall-mounted kitchen-cabinet with storage of non-potable water out of reverse osmosis (RO) water treating machine is recited and claimed in claim 1, wherein said case body of kitchen-cabinet is either singly mounted on the wall in manner of above the cleaning sink of the kitchen, or juxtaposed with existing wall-mounted kitchen-cabinet on the wall of the kitchen in abutted manner so that the artistic appearance for the wall of the kitchen is not destroyed by keeping the dimensional size of the case body of kitchen-cabinet the same as that of the existing wall-mounted kitchen-cabinet.

3. The wall-mounted kitchen-cabinet with storage of non-potable water out of reverse osmosis (RO) water treating machine is recited and claimed in claim 1, wherein said pipe inlet and pipe outlet in the case body of kitchen-cabinet is adapted to dispose on the back face of the case body of kitchen-cabinet.

4. The wall-mounted kitchen-cabinet with storage of non-potable water out of reverse osmosis (RO) water treating machine is recited and claimed in claim 1, wherein said pipe inlet and pipe outlet in the case body of kitchen-cabinet is adapted to dispose on the lateral face of the case body of kitchen-cabinet.

5. The wall-mounted kitchen-cabinet with storage of non-potable water out of reverse osmosis (RO) water treating machine is recited and claimed in claim 1, wherein said water outlet in the water storage tank is adapted to dispose on the side face of the water storage tank.

6. The wall-mounted kitchen-cabinet with storage of non-potable water out of reverse osmosis (RO) water treating machine is recited and claimed in claim 1, wherein a float switch is further disposed in the internal wall in manner of beneath the water inlet of the water storage tank to prevent the non-potable water from overflowing out of the water storage tank.

7. The wall-mounted kitchen-cabinet with storage of non-potable water out of reverse osmosis (RO) water treating machine is recited and claimed in claim 1, wherein an electronic water level detector is further disposed in the internal wall in manner of near to the top surface of the water storage tank to prevent the non-potable water from overflowing out of the water storage tank.

8. The wall-mounted kitchen-cabinet with storage of non-potable water out of reverse osmosis (RO) water treating machine is recited and claimed in claim 1, wherein said water stopcock, which is connected to the end opening of the outlet pipe, is able to dispose either over or in the cleaning sink.

9. The wall-mounted kitchen-cabinet with storage of non-potable water out of reverse osmosis (RO) water treating machine is recited and claimed in claim 1, wherein a gooseneck faucet is connected to the end opening of the outlet pipe to enhance flexibility and maneuverability in using the non-potable water.

10. The wall-mounted kitchen-cabinet with storage of non-potable water out of reverse osmosis (RO) water treating machine is recited and claimed in claim 1, wherein an ultraviolet (UV) lamp is further disposed in the internal wall in manner of beneath of the cover of water storage tank to serve as a disinfecting means for sterilizing harmful microorganisms grown in the non-potable water by means of the effective germicidal capability thereof.

11. The wall-mounted kitchen-cabinet with storage of non-potable water out of reverse osmosis (RO) water treating machine is recited and claimed in claim 10, wherein the ultraviolet (UV) lamp is replaced by a submersible ultraviolet (UV) lamp disposed in the water storage tank, which has the same germicidal effectiveness to sterilize these harmful microorganisms grown in the non-potable water of the water storage tank.
